(19) United States
(12) Patent Application Publication
(10) Pub. No.: US 2019/0293273 A1
(43) Pub. Date: Sep. 26, 2019

(54) METHOD AND APPARATUS FOR DISPLAYING LIGHT FIXTURES

(71) Applicant: E-B Display Company, Inc., Massillon, OH (US)

(72) Inventor: Jason Wayne Brown, Hamptonville, NC (US)

(21) Appl. No.: 15/934,453

(22) Filed: Mar. 23, 2018

(51) Int. Cl. F21V 23/00; A47F 11/10

(52) U.S. Cl. CPC F21V 23/002; A47F 11/10

(57) ABSTRACT

A system and method for a light fixture on a retail display includes a wiring harness disposed on an opposite side of hanger bracket than a plug on a power cord extending transversely through the hanger bracket. The wire or wiring harness allows for a light fixture to be installed on or uninstalled from the hanger bracket without having to move the hanger bracket or unplug the power cord from a power outlet located in a channel beneath the hanger bracket. The wiring harness is insulated so as to protect an operate from current moving through the power cord when changing or replacing the light fixture.

### BACKGROUND

### Technical Field

The present disclosure relates generally to a system and method for light fixtures on a retail display. More particularly, the present disclosure relates to a system and method incorporating a wiring harness to allow a light fixture to be installed or uninstalled without unplugging a power cord or removing a hanger bracket from the retail display.

### Background Information

In conventional brick and mortar home improvement stores, such as Lowe's, Home Depot, Menard's, Ace Hardware, True Value, Sears, or the like, light fixtures are prominently displayed so a customer views an assembled and temporarily installed version of the light fixture they desire to purchase. Typically, light fixtures are displayed or installed on a display assembly, which may also be referred to as a retail display.

The retail display includes a substantially planar surface that may be oriented either vertically or horizontally. The retail display includes rails that are generally coplanar with the planar surface and define a channel. A hanger bracket connects with the rails. Typically, a light fixture is mounted either directly or indirectly with the hanger bracket. A power cord extends through the hanger bracket and is directly wired to the wires on the light fixture. The power cord is plugged into a power outlet located in the channel that is covered by hanger bracket when the hanger bracket is pivoted into the channel.

Currently, when light fixture needs to be replaced, a store employee or a third-party independent contract must detach the hanger bracket from the rails in order to unplug the power cord before disconnecting the fixture wires from the power cord wires. This is difficult inasmuch as at least one flex tab on the hanger bracket must be flexible moved to disengage the hanger bracket from the rail. Typically, the flex tabs are fabricated from metal and do not bend or flex easily. This makes it difficult to move the hanger bracket to expose the plug and power outlet at the bottom of the channel.

Due to the difficultly of detaching the hanger bracket from the rails, store employees have been trying to uninstall the light fixture without removing the hanger bracket from the rails. Because the power cord cannot be unplugged without first moving the hanger bracket out of the way, when the employee attempts to change the light fixture, they are often shocked or electrocuted when they touch the live power wires.

### SUMMARY

A person touching a live power wire is clearly a dangerous situation that needs addressed. Thus, a need continues to exist for a retail display for light fixtures that enables a person to change or replace a light fixture without detaching the hanger bracket that covers the power outlet and the power cord plugged therein. The present disclosure addresses these and other issues by providing an assembly with a wiring harness located on an opposite side of the hanger bracket than the plug and power outlet. This allows a user to detach a live power wire in order uninstall a light fixture and re-install a second light fixture without moving the flex tabs, or the hanger bracket, or the plug on the power cord.

In accordance with one aspect, an exemplary embodiment of the present disclosure may provide a system for a light fixture on a retail display comprising: a hanger bracket having first and second ends defining a longitudinal direction therebetween, first and second sides defining a lateral direction therebetween, and opposing first and second surfaces defining a transverse direction therebetween; a power cord including a first end and a second end, wherein the first end defines a plug; at least one aperture formed in hanger bracket extending transversely from the first surface to the second surface, wherein the power cord extends through the at least one aperture; and a quick disconnect coupler located opposite, relative to the first surface, the plug on the power cord, and the quick disconnect coupler adapted to electrically disconnect a light fixture while the hanger bracket remains in an installed position and the plug is plugged into a power outlet. This exemplary embodiment or another exemplary embodiment may further provide a wiring harness, wherein the quick disconnect coupler is carried by the wiring harness and separates the wiring harness into first and second portions when the quick disconnect coupler is disconnected; wherein the wiring harness is located opposite, relative to the first surface, the plug on the power cord. This exemplary embodiment or another exemplary embodiment may further provide rails defining a channel on the retail display, and the hanger bracket pivotable into and out of the channel, and wherein the power outlet is located in the channel; wherein when the plug is plugged into the power outlet, the second surface of the hanger bracket covers the plug and power outlet; and the quick disconnect coupler including first and second connectors, wherein the first portion of the wiring harness having the first connector has no electrical current when separated from the second connector and the power cord is plugged into the power outlet. This exemplary embodiment or another exemplary embodiment may further provide a ground wire coupled with the hanger bracket, wherein the ground wire includes at least one coupler to separate the ground wire into two segments, and the two segments of the ground wire are located opposite, relative to the first surface, the plug on the power cord. This exemplary embodiment or another exemplary embodiment may further provide a flange connector at the first end of the hanger bracket inclined relative to the first surface; a flex tab connector at the second end of the hanger bracket; wherein the wiring harness is adjacent the first surface of the hanger bracket between the flange connector and the flex tab connector.

In accordance with another aspect, an exemplary embodiment of the present disclosure may provide a method of installing a light fixture on a retail display: coupling wires on the light fixture to a first portion of a wiring harness; coupling a hanger bracket to the retail display; plugging a power cord carried by a hanger bracket into a power outlet on the retail display; covering a portion of the power cord with the hanger bracket; coupling, via a quick disconnect coupler, a second portion of the wiring harness and the first portion of the wiring harness; and connecting, directly or indirectly, the light fixture to the hanger bracket.

In accordance with another aspect, an exemplary embodiment of the present disclosure may provide a method of uninstalling a light fixture from a retail display comprising: removing a decorative flange on the light fixture to expose a wiring harness; disconnecting a quick disconnect coupler on the wiring harness to separate the wiring harness into first and second portions; wherein disconnecting the quick disconnect coupler is accomplished when a plug on a power cord is plugged into a power outlet at least partially obstructed relative to the light fixture; and removing the light fixture from a hanger bracket, wherein the wiring harness and the plug on the power cord are on opposite sides of the hanger bracket such that the light fixture is uninstalled without removing the hanger bracket from the retail display.

In accordance with another aspect, an exemplary embodiment of the present disclosure may provide a method of replacing light fixtures on a retail display comprising: disconnecting a first light fixture from a hanger bracket on the retail display; maintaining the hanger bracket in a channel defined between two rails on the retail display; maintaining electrical current through the power cord via a plug plugged into a power outlet located in the channel and covered by the hanger bracket; disconnecting a quick disconnect coupler on a wiring harness connected with the first light fixture; connecting the quick disconnect coupler on the wiring harness with a second light fixture while electrical current is maintained in the power cord; and connecting the second light fixture to the hanger bracket.

In accordance with another aspect, an exemplary embodiment of the present disclosure may provide a system and method for a light fixture on a retail display including a wiring harness disposed on an opposite side of hanger bracket than a plug on a power cord extending transversely through the hanger bracket. The wire or wiring harness allows for a light fixture to be installed on or uninstalled from the hanger bracket without having to move the hanger bracket or unplug the power cord from a power outlet located in a channel beneath the hanger bracket. The wiring harness is insulated so as to protect an operate from current moving through the power cord when changing or replacing the light fixture.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is an exploded perspective view of a system for a light fixture on a retail display.

FIG. 2 is a partially assembled perspective view of the system for the light fixture on the retail display.

FIG. 3 is an assembled perspective view of the system for the light fixture on the retail display.

FIG. 4 is an exploded perspective view of a system for a light fixture on a retail display utilizing an auxiliary or a secondary mounting bracket.

FIG. 5 is a flow chart in accordance with one exemplary method or process associated with the system for a light fixture on a retail display.

FIG. 6 is a flow chart in accordance with one exemplary method or process associated with the system for a light fixture on a retail display.

FIG. 7 is a flow chart in accordance with one exemplary method or process associated with the system for a light fixture on a retail display.

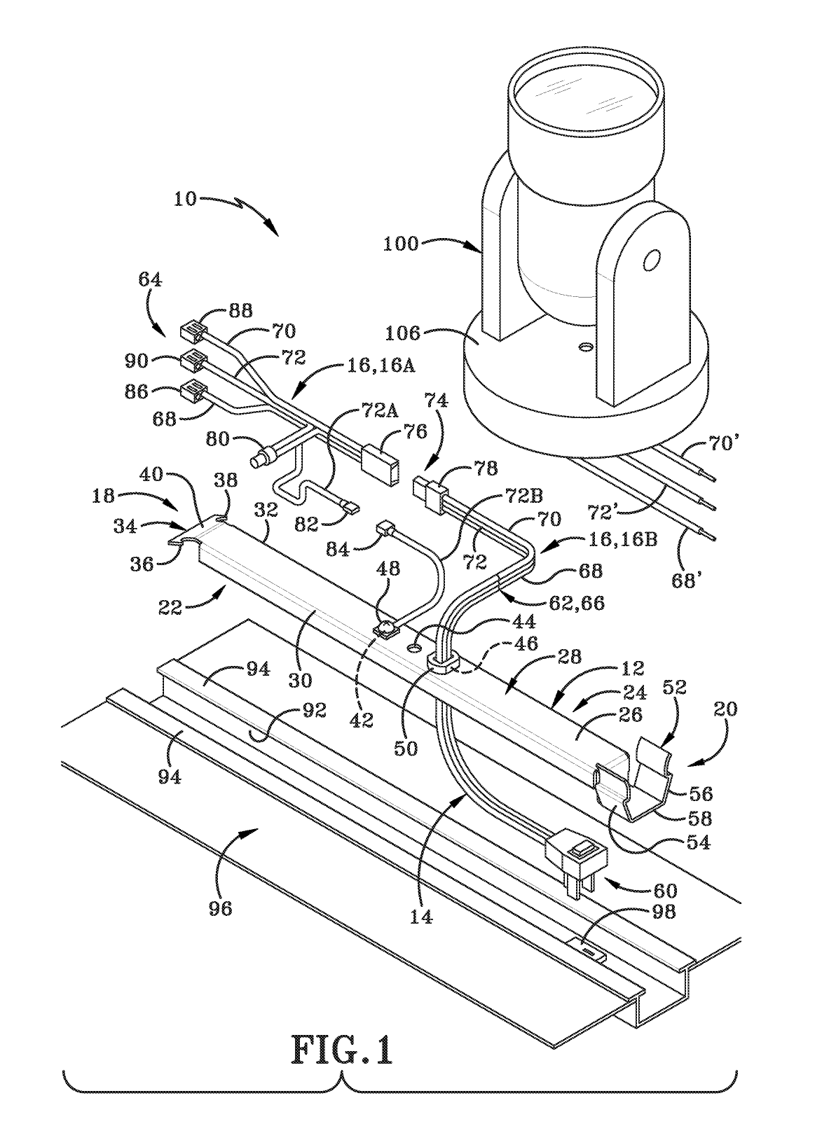

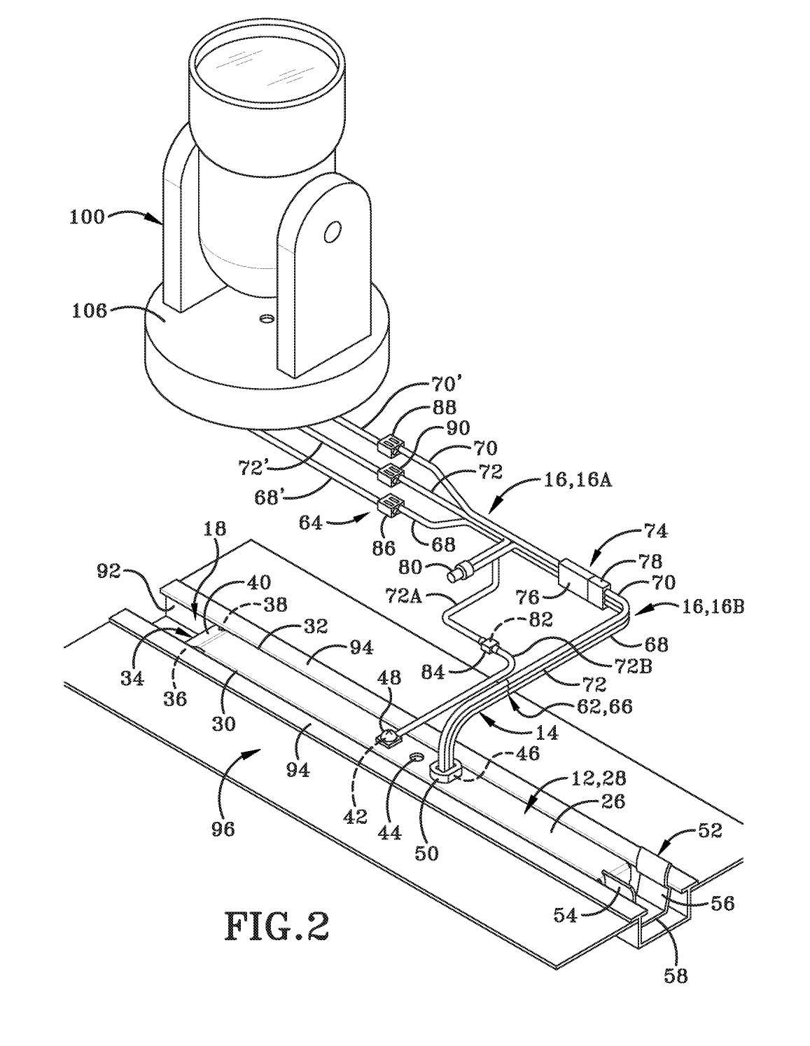

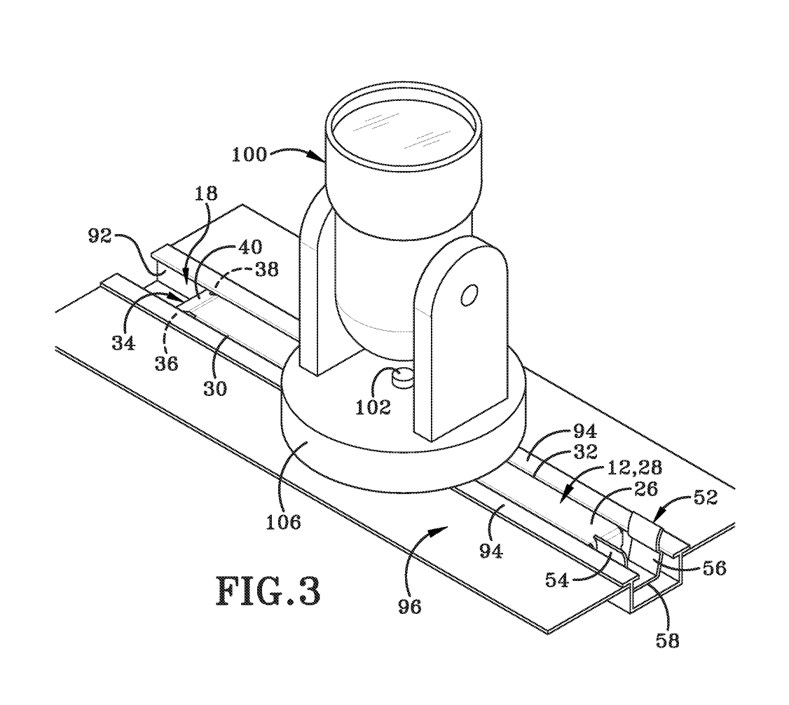

Similar numbers refer to similar parts throughout the drawings.

### DETAILED DESCRIPTION

A device in accordance with the present disclosure is shown generally at 10. The device 10 is a light fixture hanger bracket assembly having a wiring harness attached thereto in order to effectuate a quick connection and disconnection of a light fixture to the hanger bracket. The device 10 may include a hanger bracket 12, a three-prong power cord 14, and a wiring harness 16 collectively defined by a first portion 16A and a second portion 16B.

The hanger bracket 12 includes a first end 18 opposite a second end 20 defining a longitudinal direction therebetween. Hanger bracket 12 includes a first side 22 opposite a second side 24 defining a lateral direction therebetween. Hanger bracket 12 additionally includes a first major surface 26 opposite a second major surface (not shown) defining a transverse direction therebetween.

Hanger bracket 12 includes a longitudinally extending rigid body 28. Rigid body 28 is formed from three connected walls rigidly and fixedly secured together to define a U-shape configuration when viewed in cross-section. The longitudinal dimension of the body 28 is the largest dimension thereof. The central portion of the rigid body 28 defines the first major surface 26 and the opposing second major surface. The outer walls of the rigid body 28 are defined by short transversely extending flanges that extend in the same direction from the first major surface 26. In one particular embodiment, the rigid body 28 may be formed as an integral member having the flanges bent to define a first longitudinally extending edge 30 and a second longitudinally extending edge 32. The major surface 26 is substantially bound between the first edge 30 and the second edge 32. The two outer walls of the rigid body 28 define minor surfaces. Particularly, a first minor surface faces the first side 22 and a second minor surface faces the second side 24 of the hanger bracket 12. An internal space defined by the U-shaped configuration of the rigid body 28 receives a portion of the power cord 14 therein when the device 10 is installed in a retail display setting.

A tab connector 34 is rigidly coupled with the rigid body 28 adjacent the first end 18 of the hanger bracket 12. Tab connector 34 includes a first hook 36 and a second hook 38 which are configured to respectively connect with first and second channels on a retail light fixture display system. The first hook 36 is associated with the first side 22 and the second hook 38 is associated with the second side 24 of the hanger bracket 12. A major surface 40 of the tab connector 34 is downwardly or transversely inclined relative to the first major surface 26 of the rigid body 28.

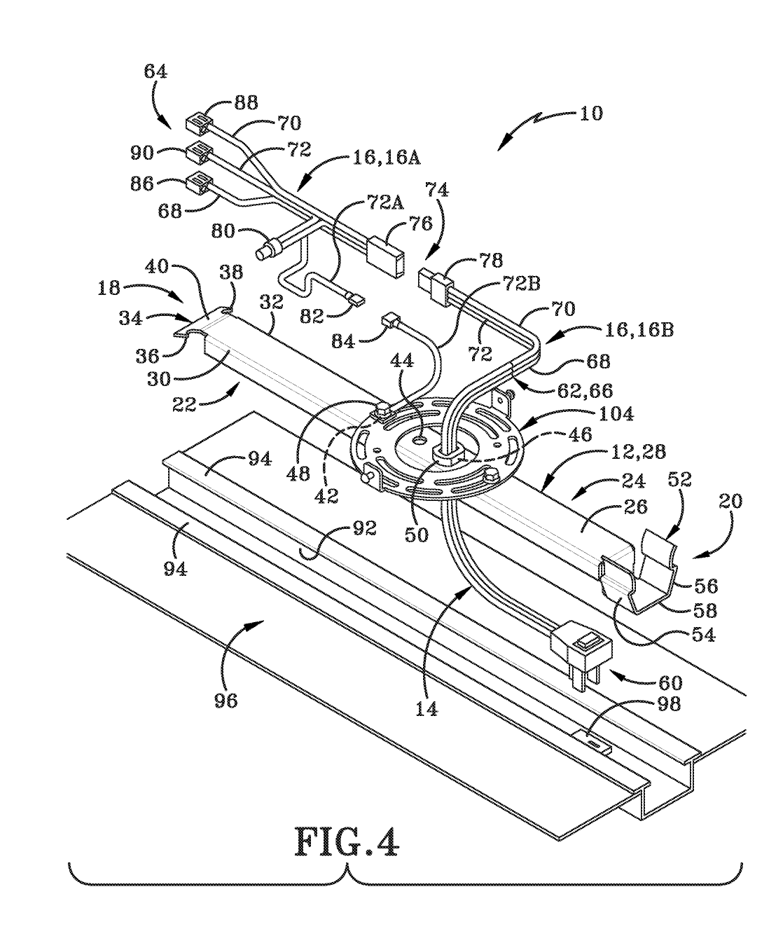

The rigid body 28 defines a transversely extending first aperture 42, a transversely extending second aperture 44, and a transversely extending third aperture 46. In one particular embodiment, the first aperture 42, the second aperture 44, and a third aperture 46 are longitudinally aligned. The second aperture, in one particular embodiment, may be located approximately midway between the first end 18 and the second end 20 on rigid body 28. The first aperture 42 may be offset towards the first end 18 from the second aperture 44, which also may be referred to as a central aperture. The third aperture 46 may be offset towards the second end 20 from the central second aperture 44. In one particular embodiment, the central second aperture 44 is adapted to receive a threaded bolt which is utilized to hang and support the weight of a light fixture. Alternatively, the second aperture 44 can directly or indirectly support a secondary or auxiliary bracket 104 (FIG. 4) to mount a shortened profile light fixture, such as a sconce. As will be described in greater detail below, the first aperture 42, in one particular embodiment, may receive a connector 48 therein to secure a portion of a ground wire to the hanger bracket 12. In one embodiment, the connector 48 is a threaded screw. Similarly, as will be described in greater detail below, in one particular embodiment, the third aperture 46 receives a portion of the power cord 14 therethrough. In one particular embodiment, a grommet 50 surrounds the power cord 14 as it extends transversely through the third aperture 46. The grommet 50 may define an annular channel that receives an edge that defines the third aperture 46.

Adjacent the second end 20 of the hanger bracket 12, a connector 52 is sized and configured to enable the hanger bracket 12 to releasably connect with rails or channels in a light fixture retail display. In one particular embodiment, the connector 52 is a flex connector formed from semi-rigid components that flex inwardly and outwardly to enable portions of the connector 52 to attach with rails or channels on the retail display. More particularly, connector 52 may include a first flex tab 54, a second flex tab 56, and a connecting flange 58. The connecting flange 58 extends laterally between the first flex tab 54 and the second flex tab 56. Collectively, the first flex tab 54, the second flex tab 56, and the connecting flange 58 are arranged in a U-shaped configuration that faces an opposite direction of the rigid body 28. Stated otherwise, the connector 52 is upwardly opened in the same direction as the major surface 26. Further stated otherwise, the upwardly opened U-shaped configuration of the connector 52 is aligned opposite as the downwardly opened U-shaped rigid body 28. As will be described in greater detail below, the flex tabs cooperate to flex inwardly and outwardly to engage the rails of the retail display.

The three-prong power cord 14 includes a three-pronged plug or first end 60 opposite a second end 62 that is configured to be attached with the wiring harness 16. The three wires of the power cord 14 are associated with a power wire, a neutral wire, and a ground wire as one having ordinary skill in the art would understand. The power cord 14 extends through the rigid body 28 between the first end 60 and the second end 62. Stated otherwise, the first end 60 is located on an opposite side of the major surface 26 than the second end 62.

Collectively, the wiring harness 16 includes a first end 64 and a second end 66. The first end 64 is configured to connect with open three-wiring on an electrical light fixture, such as a lamp, sconce, chandelier, or the like. The second end 66 is connected with the second end 62 of the three-wire power cord 14. More particularly, the wiring harness 16 includes a power wire 68, a neutral wire 70, and a ground wire 72. The power wire 68 on the wiring harness 16 is connected with a respective power wire on the power cord 14. The neutral wire 70 on the wiring harness 16 is connected with a respective neutral wire on the power cord 14. The ground wire 72 on the wiring harness 16 is connected with a respective ground wire on the power cord 14. It is envisioned in one embodiment that the connections between the second end 66 of the wiring harness 16 and the second end 62 of the power cord 14 are effectuated and accomplished through a semi-permanent configuration or union. The term semi-permanent union or semi-permanent configuration refers to a connection that is not a quick disconnection as will be described in greater detail below. The semi-permanent union or connection may be effectuated through the use of wire nuts or soldering. Alternatively, other known semi-permanent connections are envisioned in which they are not designed to be easily disconnected. For example, an exposed wire from the second end 66 of the wiring harness 16 may be twistably connected with an exposed wire of the second end 62 of the three-prong power cord 14. The wires that are twisted together between the second end 62 and the second end 66 may then be slipcovered with an insulator, such as a rubber sleeve, that may be heat sealed and shrunk to create the connection between the wiring harness 16 and the power cord 14. Thus, it is envisioned that the term semi-permanent refers to a connection that is physically capable of being disconnected; however, it is not intended to be disconnected in routine practice.

Wire harness 16 includes a quick disconnect connection 74 that segregates the wiring harness 16 into the first portion 16A and the second portion 16B. The quick disconnect coupler 74 may further be defined as a releasable coupler or releasable coupling or an electrical wire connector. As used herein, the term “quick disconnect” refers to a type of coupler or electrical wire connector that may be easily pulled apart or separated and is intended to repeatably connect and disconnect. A first segment 76 of the releasable coupler is attached to an end of the first portion 16A of the wiring harness 16. A second segment 78 of the quick disconnect coupler 74 is connected with an end of the second portion 16B of the wiring harness 16. The first segment 76 mateably and releaseably connects with the second segment 78 on the second portion 16B. Both connectors or segments 76, 78 should be electrically insulated to prevent an operator from touching an live wire or electrical current present in any portion of the wiring harness 16. Within each respective segment 76, 78, the three wires 68, 70, and 72 are connected with lead terminals. The lead terminals within the respective segments 76, 78 of the quick disconnect coupler are arranged so as to complete the electrical connection of each respective wire when the quick disconnect coupler 74 is mateably connected. Stated otherwise, the power wire 68 from the first portion 16A will send signals to the power wire 68 in the second portion 16B when the quick disconnect coupler 74 is mateably connected. The neutral wire 70 on the first portion 16A will send signals along the neutral wire 70 in the second portion 16B when the quick disconnect coupler 74 is mateably connected. The ground wire 72 on the first portion 16A connects with the first segment 76 and is split into an auxiliary ground segment 72A through a wire nut 80 union. The auxiliary ground segment 72A includes a first quick disconnect segment 82 which mateably connects with a second quick disconnect segment 84 on the second auxiliary ground wire 72B. The second auxiliary ground wire 72B is electrically connected with the connector 48 at the first aperture 42 of the rigid body 28.

Notably, an alternative embodiment of a power cord may be provided that utilizes the standard power cord 14 and simply attaches one of the segments or connectors from the quick disconnect coupler 74 directly thereto, thus eliminating the need for the second portion 16B of the wiring harness 16. In this instance, the power cord 14 would extend transversely through the hanger bracket 12 and the end 62 would terminate in the second connector or segment 78.

With continued reference to the first portion 16A, a wiring connector 86 is attached to a forward terminal end of the power wire 68 defining the first end 64 of the wiring harness 16. A connector 88 is attached with the forward terminal end of the neutral wire 70 defining a portion of the first end 64 of the wiring harness 16. A connector 90 is connected with the forward terminal end of the ground wire 72 defining the first end 64 of the wiring harness 16. The connectors 86, 88, and 90 are sized and configured to receive respective electrical wires from a light fixture therein in order to couple the wiring harness 16 to the power supply fed through the three-prong power cord 14.

The wiring harness 16 is located on an opposite side of the hanger bracket 12 than the first end 60 of the three-prong power cord 14. Stated otherwise, when the three-prong power cord 14 is plugged into a power outlet and positioned behind the hanger bracket 12, the wiring harness 16 is external to the retail display apparatus so as to allow a light fixture, such as a sconce or chandelier, or other light fixture to be quickly connected and disconnected without unplugging the plug at the first end 60 of the power cord 14 from the power outlet located within a channel of the retail display.

In one particular embodiment, the quick disconnect coupler 74 is effectuated by connectors 76, 78 that enable the wiring harness 16 to be disconnected under a power load (when the first end 60 of three-prong power cord 14 is plugged into a power supply) to prevent accidental shock of an operator. The configuration of device 10 allows the wiring harness 16 to be removed from either an overhead position or vertically aligned position on a retail display to allow for easy electrical connections. In one particular embodiment, the quick disconnect coupler 74 is accomplished through the use of a male connector as the first segment 76, and a female connector as the second segment 78. One exemplary and non-limiting connector envisioned to effectuate the quick disconnect coupling 74 are Molex connectors.

In another particular embodiment, the connectors 86, 88, and 90 located adjacent the forward terminal ends of the wiring harness 16 enable quick attachments for lighting fixtures. In one particular embodiment, the connectors 86, 88, and 90 are accomplished through the use of Wacco connectors which are commercially available for sale. The first connector 82 on the auxiliary ground wire 72A may be a male or female ground wire connector which allows the wiring harness 16A to be removed from the overhead position or the vertically aligned position on the retail lighting fixture to allow for easy electrical connections.

In accordance with one aspect of the present disclosure, the device 10 provides a light fixture hanger with a quick disconnect wiring harness 16 that is configured to reduce the likelihood that an operator installing or removing a light fixture with the hanger bracket 12 will be electrically shocked. Particularly, the device 10 enables an operator to disconnect the light fixture from the power source by disconnecting the quick disconnect coupler 74 without removing the hanger bracket 12 or disconnecting the three-prong power cord 14 from the power supply.

In operation, it is envisioned that one set of exemplary use or installation steps may be provided. However, other scenarios are envisioned as well. For example, the device 10 may be provided to a user in a manner that is partially separated. In this instance, the first portion 16A of the wiring harness 16 is provided to the user separate from the second portion 16B. The user may attach the connectors 86, 88, and 90 to the respective free ends 68′, 70′, 72′ of the wiring for the light fixture. The user may then install the hanger bracket 12 by inserting the tab connector 34 into the channels 92 defined by the adjacent rails 94 of the retail display 96. The tab connector 34 pivotably connects the hanger bracket 12 to the rails 94 to allow the power cord 14 to be plugged into an outlet 98 of the power supply. With the plug at the first end 60 of the power cord 14 connected to an outlet 98 of the power supply, the hanger bracket 12 may then be press fit into the channel between adjacent parallel rails 94 on the retail display 96 by flexing tabs 52, 54. The hanger bracket 12 is pivoted so as to move the hanger bracket 12 into a longitudinal alignment with the channel 92 of the retail display. The flex tab connector 52 may be squeezed together so as to narrow the lateral dimension of the tab connector 52 to enable it to fit through the maximum lateral dimension of the channel. Once the hanger bracket 12 is within the channel, the flex tab connector 52 may be released so that the first flex tab 54 and the second flex tab 56 flare outwardly and urge against the rails 94 defining the channel in order to releasably secure the hanger bracket 12 thereto.

With the hanger bracket 12 installed on the retail display 96, the light fixture may be mounted to the hanger bracket 12. In one embodiment, a threaded pipe 102 may be used to connect with the second aperture 44 in order to attach the light fixture 100 to the hanger bracket 12. In other situations, an auxiliary bracket 104 (FIG. 4) that is generally circular in shape can be connected to the first major surface 26 of the hanger bracket 12 in order to connect the light fixture thereto. Once the light fixture 100 is physically mounted directly or indirectly (via bracket 104) to the bracket 12, the quick disconnect coupler 74 may be connected together to provide electrical power to the light fixture 100. Additionally, the ground connectors 82, 84 may be connected to provide a sufficient ground circuit with the hanger bracket 12. The wiring harness 16 is exterior to the retail light display and may then be covered up through a decorative flange 106, which is part of the light fixture 100.

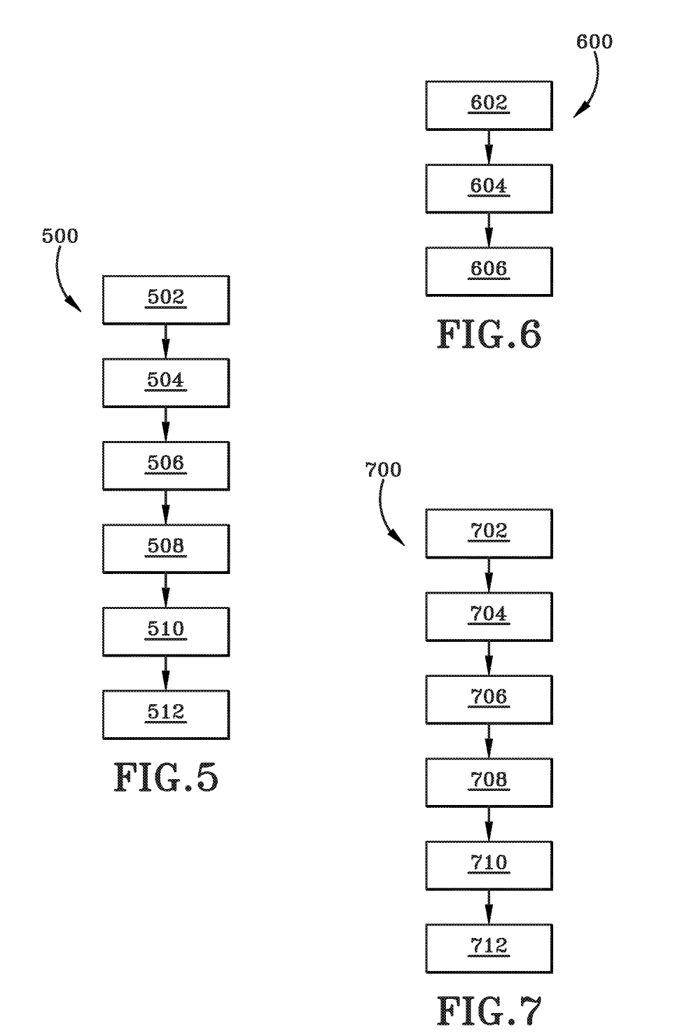

FIG. 5 depicts an exemplary method 500 in accordance with one aspect of the present disclosure. Method 500 may relate to installing the light fixture 100 on the retail display 96. Method 500 may include coupling wires on the light fixture 100 to the first portion 16A of the wiring harness 16, which is shown generally at 502. Method 500 may include coupling the hanger bracket 12 to the retail display 96, which is shown generally at 504. Method 500 may include plugging the power cord 14 carried by the hanger bracket 12 into the power outlet 98 on the retail display 96, which is shown generally at 506. Method 500 may include covering a portion of the power cord 14 with the hanger bracket 12, which is shown generally at 508. Method 500 may further include coupling, via the quick disconnect coupler 74, the second portion 16B of the wiring harness 16 and the first portion 16A of the wiring harness 16, which is shown generally at 510. Method 500 may further include connecting, directly or indirectly, the light fixture 100 to the hanger bracket 12, which is shown generally at 512. In addition to the above, Method 500 may further include covering at least a portion of the wiring harness with a portion of the light fixture, or covering the entire wiring harness with a decorative flange on the light fixture. Method 500 may also include inserting the hanger bracket 12 into the channel 92 defined by rails 94 while maintaining the second portion 16B of the wiring harness and a plug (near first end 60) on the power cord 14 on opposite sides of the hanger bracket 12. Method 500 may further include flexing the flex tab (either 52 or 54) on the hanger bracket 12; contacting the flex tab with the rail 94 on the retail display 96; and positioning the plug on the power cord and the first portion 16A of the wiring harness 16 on opposite sides of the hanger bracket 12. Method 500 may further include coupling the quick disconnect coupler 74 while the power cord 14 is plugged into the power outlet 98 disposed within the channel 92 defined by rails 94 on the retail display 96. Method 500 may further include connecting an end of the second portion 16B of the wiring harness with the end 62 of the power cord 14 to establish a semi-permanent union, wherein the semi-permanent union and the plug on the power cord 14 are disposed on an opposite sides of the hanger bracket 12. Further, Method 500 may provide establishing the semi-permanent union between the wiring harness 16 and the power cord 14 when the plug on the power cord is disconnected from the power outlet 98. Method 500 may further include connecting a ground wire 72 on the wiring harness to the hanger bracket 12. Method 500 may further include connecting a second quick disconnect coupler (established by the connection of 82, 84) on the ground wire 72 to establish a ground connection between the light fixture 100 and the hanger bracket 12. Method 500 may further provide positioning the second quick disconnect coupler (established by the connection of 82, 84) and the plug on the power cord 14 on opposite sides of the hanger bracket.

FIG. 6 depicts an exemplary method 600 in accordance with one aspect of the present disclosure. Method 600 may relate to uninstalling the light fixture 100 from the retail display 96. Method 600 may include removing the decorative flange 106 on the light fixture 100 to expose the wiring harness 16, which is shown generally at 602. Method 600 may include disconnecting the quick disconnect coupler 74 on the wiring harness 16 to separate the wiring harness into first and second portions 16A, 16B, which is shown generally at 604, wherein disconnecting the quick disconnect coupler 74 is accomplished when the plug on the power cord 14 is plugged into the power outlet 98 at least partially obstructed relative to the light fixture 100 due to the hanger bracket body 28. Method 600 may further include removing the light fixture 100 from the hanger bracket 12, wherein the wiring harness 16 and the plug on the power cord 14 are on opposite sides of the hanger bracket 16 such that the light fixture 100 is uninstalled without removing the hanger bracket 12 from the retail display 96, which is shown generally at 606. Method 600 may further include disconnecting the first portion 16A of the wiring harness 16 from the light fixture 100 by separating and exposing wires 68, 70′, and 72′ on the light fixture 100 from three respective couplers 86, 88, 90 on the first portion 16A of the wiring harness 100. Method 600 may further include disconnecting a coupler (either connector 82 or 84) on the ground wire 72 to separate the ground wire into first and second segments 72A, 72B, wherein the first segment 72A of ground wire is part of the first portion of the wiring harness 16A and the second segment 72B of the ground wire is coupled with the hanger bracket 12 on an opposite side than the plug on the power cord 14, wherein disconnecting the coupler on the ground wire is accomplished while the plug is plugged into the power outlet 98. Method 600 may further include maintaining electrical power, via the power outlet 98 located in the channel 92 defined by rails 94 in the display 96 underneath the hanger bracket 12, in the power cord 14 while the wiring harness 16 is disconnected into the first and second portions 16A, 16B, and no electricity flows through the first portion 16A of the wiring harness when disconnected from the second portion 16B of the wiring harness 16.

FIG. 7 depicts an exemplary method 700 in accordance with one aspect of the present disclosure. Method 700 may relate to a method of replacing light fixtures on a retail display. Method 700 may include disconnecting a first light fixture 100 from the hanger bracket 12 on the retail display 96, which is shown generally at 702. Method 700 includes maintaining the hanger bracket 12 installed in the channel 92 defined between two rails 94 on the retail display 96, which is shown generally at 704. Method 700 includes maintaining electrical current through the power cord 14 via a plug plugged into a power outlet 98 located in the channel 92 and covered by the hanger bracket 12, which is shown generally at 706. Method 700 includes disconnecting the quick disconnect coupler 74 on the wiring harness 16 connected with the first light fixture, which is shown generally at 708. Method 700 includes connecting the quick disconnect coupler 74 on the wiring harness with a second light fixture while electrical current is maintained in the power cord 14, which is shown generally at 710. Method 700 includes connecting the second light fixture to the hanger bracket 12, which is shown generally at 712. Method 700 may further include hiding the wiring harness 16 behind a decorative flange 106 on the second light fixture, wherein the wiring harness is disposed between the decorative flange 106 and an outer first major surface 26 on the hanger bracket 12. Method 700 may further include pivoting the hanger bracket 12 relative to the rails 94 into an installed position after plugging the plug into the power outlet 98, and replacing the first light fixture with the second light fixture without moving the hanger bracket 12 from the installed position, and supplying power to the second light fixture without unplugging the plug from the outlet 98 beneath the hanger bracket 12.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A system for a light fixture on a retail display comprising:
a hanger bracket having first and second ends defining a longitudinal direction therebetween, first and second sides defining a lateral direction therebetween, and opposing first and second surfaces defining a transverse direction therebetween;
a power cord including a first end and a second end, wherein the first end defines a plug;
at least one aperture formed in hanger bracket extending transversely from the first surface to the second surface, wherein the power cord extends through the at least one aperture; and
a quick disconnect coupler located opposite, relative to the first surface, the plug on the power cord, and the quick disconnect coupler adapted to electrically disconnect a light fixture while the hanger bracket remains in an installed position and the plug is plugged into a power outlet.

2. The system for the light fixture on the retail display of claim 1, further comprising:
a wiring harness, wherein the quick disconnect coupler is carried by the wiring harness and separates the wiring harness into first and second portions when the quick disconnect coupler is disconnected;
wherein the wiring harness is located opposite, relative to the first surface, the plug on the power cord.

3. The system for the light fixture on the retail display of claim 2, further comprising:
rails defining a channel on the retail display, and a hanger bracket pivotable into and out of the channel, and wherein the power outlet is located in the channel;
wherein when the plug is plugged into the power outlet, the second surface of the hanger bracket covers the plug and power outlet; and
the quick disconnect coupler including first and second connectors, wherein the first portion of the wiring harness having the first connector has no electrical current when separated from the second connector and the power cord is plugged into the power outlet.

4. The system for the light fixture on the retail display of claim 3, further comprising:
a ground wire coupled with the hanger bracket, wherein the ground wire includes at least one coupler to separate the ground wire into two segments, and the two segments of the ground wire are located opposite, relative to the first surface, the plug on the power cord.

5. The system for the light fixture on the retail display of claim 4, further comprising:
a flange connector at the first end of the hanger bracket inclined relative to the first surface;
a flex tab connector at the second end of the hanger bracket;
wherein the wiring harness is adjacent the first surface of the hanger bracket between the flange connector and the flex tab connector.

6. A method of installing a light fixture on a retail display comprising:
coupling wires on the light fixture to a first portion of a wiring harness;
coupling a hanger bracket to the retail display;
plugging a power cord carried by a hanger bracket into a power outlet on the retail display;
covering a portion of the power cord with the hanger bracket;
coupling, via a quick disconnect coupler, a second portion of the wiring harness and the first portion of the wiring harness; and
connecting, directly or indirectly, the light fixture to the hanger bracket.

7. The method of installing the light fixture on the retail display of claim 6, further comprising:
covering at least a portion of the wiring harness with a portion of the light fixture.

8. The method of installing the light fixture on the retail display of claim 7, further comprising:
covering the entire wiring harness with a decorative flange on the light fixture.

9. The method of installing the light fixture on the retail display of claim 6, further comprising:
inserting the hanger bracket into a channel defined by rails while maintaining the second portion of the wiring harness and a plug on the power cord on opposite sides of the hanger bracket.

10. The method of installing the light fixture on the retail display of claim 6, further comprising:
flexing a flex tab on the hanger bracket;
contacting the flex tab with a rail on the retail display; and
positioning a plug on the power cord and the first portion of the wiring harness on opposite sides of the hanger bracket.

11. The method of installing the light fixture on the retail display of claim 6, further comprising:
coupling the quick disconnect coupler while the power cord is plugged into the power outlet disposed within a channel defined by rails on the retail display.

12. The method of installing the light fixture on the retail display of claim 6, further comprising:
connecting an end of the second portion of the wiring harness with an end of the power cord to establish a semi-permanent union, wherein the semi-permanent union and a plug on the power cord are disposed on an opposite sides of the hanger bracket.

13. The method of installing the light fixture on the retail display of claim 12, further comprising:
establishing the semi-permanent union between the wiring harness and the power cord when the plug on the power cord is disconnected from the power outlet.

14. The method of installing the light fixture on the retail display of claim 6, further comprising:
connecting a ground wire on the wiring harness to the hanger bracket.

15. The method of installing the light fixture on the retail display of claim 6, further comprising:
connecting a second quick disconnect coupler on the ground wire to establish a ground connection between the light fixture and the hanger bracket.

16. The method of installing the light fixture on the retail display of claim 15, further comprising:
positioning the second quick disconnect coupler and a plug on the power cord on opposite sides of the hanger bracket.

17. The method of installing the light fixture on the retail display of claim 6, further comprising:
disconnecting the first light fixture from the hanger bracket on the retail display;
maintaining the hanger bracket in the channel defined between two rails on the retail display;
maintaining electrical current through the power cord via the plug plugged into the power outlet located in the channel and covered by the hanger bracket;
disconnecting the quick disconnect coupler on the wiring harness connected with the first light fixture;
connecting the quick disconnect coupler on the wiring harness with a second light fixture while electrical current is maintained in the power cord; and
connecting the second light fixture to the hanger bracket.

18. The method of claim 17, further comprising:
pivoting the hanger bracket relative to the rails into an installed position after plugging the plug into the power outlet;
replacing the first light fixture with the second light fixture without moving the hanger bracket from the installed position; and
supplying power to the second light fixture without unplugging the plug from the outlet beneath the hanger bracket.

19. A method of uninstalling a light fixture from a retail display comprising:
removing a decorative flange on the light fixture to expose a wiring harness;
disconnecting a quick disconnect coupler on the wiring harness to separate the wiring harness into first and second portions;
wherein disconnecting the quick disconnect coupler is accomplished when a plug on a power cord is plugged into a power outlet at least partially obstructed relative to the light fixture; and
removing the light fixture from a hanger bracket, wherein the wiring harness and the plug on the power cord are on opposite sides of the hanger bracket such that the light fixture is uninstalled without removing the hanger bracket from the retail display.

20. The method of uninstalling the light fixture from the retail display of claim 19, further comprising:
disconnecting the first portion of the wiring harness from the light fixture by separating and exposing wires on the light fixture from three respective couplers on the first portion of the wiring harness.

21. The method of uninstalling the light fixture from the retail display of claim 19, further comprising:
disconnecting a coupler on a ground wire to separate the ground wire into first and second segments, wherein the first segment of ground wire is part of the first portion of the wiring harness and the second segment of the ground wire is coupled with the hanger bracket on an opposite side than the plug on the power cord;
wherein disconnecting the coupler on the ground wire is accomplished while the plug is plugged into the power outlet.

22. The method of uninstalling the light fixture from the retail display of claim 19, further comprising:
maintaining electrical power, via the power outlet located in a channel defined by rails in the display underneath the hanger bracket, in the power cord while the wiring harness is disconnected into the first and second portions, and no electricity flows through the first portion of the wiring harness when disconnected from the second portion of the wiring harness.
